(19) United States
(12) Patent Application Publication
(10) Pub. No.: US 2017/0169533 A1
(43) Pub. Date: Jun. 15, 2017

(54) WORN PERSONAL PROTECTIVE EQUIPMENT COMPLIANCE SYSTEM

(71) Applicant: Corvex Connected Safety Inc., Cottage Grove, MN (US)

(72) Inventor: Joe O'Brien, North Oaks, MN (US)

(21) Appl. No.: 15/379,688

(22) Filed: Dec. 15, 2016

Related U.S. Application Data
(60) Provisional application No. 62/267,365, filed on Dec. 15, 2015.

(51) Int. Cl. G06Q 50/26; G06Q 30/00

(52) U.S. Cl. CPC G06Q 50/265; G06Q 30/018; G06T 17/00

(57) ABSTRACT

The present invention comprises one or more sensing device interconnected or interoperable with personal protective equipment that senses the relationship between a person and the protective equipment, which can communicate that relationship to a software application for compliance purposes.

### RELATED APPLICATIONS

The present application claims priority to, and incorporates by reference hereto, U.S. Provisional Patent Application No. 62/267,365 of the same title filed Dec. 15, 2015.

### BACKGROUND OF THE INVENTION

Field

The present invention relates to a personal protective equipment (“PPE”) compliance system. In particular, the invention comprises one or more sensing devices that monitor the relationship between a person and piece of protective equipment, which can communicate that relationship to a software application for compliance purposes.

Background

The use of proper and effective PPE is one of the best tools to protect workers from injury on the job. In fact, the Occupational Safety & Health Administration (“OSHA”) has established a wide range and array of guidelines and rules that require workers to use all manner of PPE to reduce and/or eliminate employee injuries and exposure to hazards when engineering and administrative controls are not feasible or effective. Other organizations, at other levels of government, trade groups, industry groups, safety organizations, and individual business have done the same.

The cost of workplace injury is staggering. In the United States, the direct cost of all reported lost-time workplace injuries is estimated at over $61 billion dollars, or approximately $40,000 per injury. Direct costs include workers compensation payments, medical expenses, and the cost of legal services. US employers pay over $1 billion per week for workers compensation costs alone.

In multiple surveys of workers in various industries, an overwhelming percentage of workers and safety professionals indicate that workplace accidents and injuries are major concerns. Given the broad concern over workplace injuries and the importance of the use of proper PPE for worker safety, it would be expected that compliance with PPE programs would be naturally quite high.

Yet, the contrary is true. Non-compliance with PPE programs remains a consistent problem. Data from the Bureau of Labor Statistics (“BLS”) consistently shows that among workers who sustain a variety of workplace injuries, the vast majority were not wearing proper PPE.

One survey identifies the highest PPE categories for regular non-compliance. The following percentage of safety professionals surveyed indicated that the following PPE categories are the most challenging for compliance:
24% Eyewear
18% Hearing Protection
17% Respiratory Protection
16% Protective Apparel
14% Gloves
4% Head Protection

It is not surprising that eyewear is widely considered the most challenging PPE category. BLS statistics indicate that nearly three out of five workers who experience occupational eye injuries were found to be not wearing eye protection at the time of the injury, or wearing the wrong type of eye protection for the job. Likewise, workers surveyed cite a variety of reasons for non-compliance with PPE protocols. Various rationales for non-compliance include:
Belief the PPE is not needed despite presence of PPE protocols
Lack of comfort
Improper fit
Not attractive
PPE not available
Lack of time or management support
Lack of training
PPE interferes with ability to do the job.

Employee training and management support are key factors to drive compliance. PPE requirements vary greatly for workers performing different functions in different locations. It can be very challenging for Health, Safety & Environment (“HSE”) managers to design, train, and implement comprehensive organizational safety programs which effectively address all hazards and risks in complex areas of operation. Once these plans are developed and implemented, it can be exceptionally challenging for HSE managers to ensure compliance.

Training is necessary but not sufficient. Workers can know the requirements and the risks and still not comply regularly. Additionally, requirements change and are dependent on circumstances, which complicates compliance. Punitive systems can be established, however, they suffer from drawbacks as well, such as creating a hostile environment, and they require constant oversite and monitoring. Any system that is dependent on monitoring requires a great deal of manpower, training, and is still prone to human error.

Accordingly, there is a need for an improved system for PPE compliance that eliminates the drawbacks of the prior art.

### BRIEF DESCRIPTION OF THE FIGURES

FIG. 1 is a schematic showing components of the present invention.

FIG. 2 is a schematic showing the configuration of the present invention.

### DETAILED DESCRIPTION OF THE INVENTION

The present invention comprises an intelligent system to support PPE compliance and worker safety. This system uses a combination of electronic sensors in operative communication with a software control program to monitor individual workers and visitors in the workplace (or other environments) and provide real time feedback to the safety manager and other personnel regarding compliance with established organizational safety programs. Additionally, the system provides automatic training reinforcement and compliance warnings to individual workers. The system is comprised of several components. These include the following:
A software application running in a network environment (such as the “Cloud”) communicating between a plurality of computing devices, which maps the monitored PPE area and includes rules based compliance targets and definitions by worker, worker role, worker location and time of day, and which can be accessed from any networked computing device.
A network of location/zone beacon hardware that is deployed within a work area to locate the worker in the work area at any given time. The worker wears a mobile transceiver device (described below) which is identified by the network/beacons. The device communicates the worker location to the software through the network. Alternatively, GPS may be used rather than a radio beacon system where a GPS signal is available.
Miniaturized Bluetooth Low Energy (“BLE”) communication devices incorporated into traditional PPE (such as eye protection, head protection, hearing protection, gloves, respiratory protection, apparel, shoes). The PPE mounted devices communicate the state of the worker worn PPE (on/off, closed/open, of the proper type, and the like) to the worker worn mobile transceiver device (described below).
Body worn transceiver device worn by the worker which allows the worker location to be determined, receives BLE signals from the worker worn PPE, compares the worker worn PPE to the safety plan for the workers location and role in real time and communicates the information to the software application system.

The software and firmware are the brains of the system. The system software can be customized for the customer, where they can determine the areas where PPE can be worn, which PPE must be worn, and other configuration parameters. All PPE risk zones for the customer are mapped into the software by the customer's safety management personnel. Each worker or visitor is added to the software by safety management personnel in an administrative interface. Specific PPE or other safety program requirements may be added to the system based on location, individual worker, or both. Training requirements for individuals, as they relate to compliance, may also be incorporated. Furthermore, the sensors worn by the workers communicate location information (for example using GPS type technology) to determine where the workers are in the work environment, and therefore the particular local PPE requirements in relation thereto. The sensors can be correlated to and communicate to the system which particular individual is wearing what particular PPE. The PPE zones can then be configured to make certain PPE mandatory, recommended, or optional.

For example, in a particular area it might be that eye wear is required, steel toed boots are recommended based on the worker, and gloves are optional; or, the requirements may be different depending on the person in the area (an equipment operator may be required to wear certain PPE and a supervisor required to use another type of PPE)—this provides a large measure of flexibility in defining and implementing rules and procedures in the work place.

The software and firmware system includes a dashboard that allows safety management personnel to monitor the location, and PPE compliance, of all employees and visitors in real time. The status may be monitored in relation to the particular organizational safety program which has been input into the software. Safety activity may be viewed on any computer, smartphone, or mobile device configured to access any network running the software system. Custom time-sensitive reports may be generated at any time by team, individual, zone, building, project, etc. to monitor compliance and to access the value of PPE systems and configurations.

The software when it detects the PPE is not being worn, or not correctly worn, can then send non-compliance warnings in real-time to particular individuals, as well as display warnings on the dashboard. These notifications may be generated automatically or initiated by safety management personnel. In this way, non-compliance may be immediately corrected and resulting injuries avoided.

Each individual PPE device in the system would include a BLE microsensor, or similar technology. This BLE microsensor is programmed with information which specifically identifies the PPE specifications allowing this information to be compared to the program requirements as defined in the system software. In this manner, the system is able to determine whether the user has the proper PPE for the location and activity.

Each BLE microsensor is able to sense proximity by measuring the relative signal strength to the transceiver device which is worn on the worker's belt. In addition to proximity, the BLE microsensor may detect temperature, capacitance, movement, or other conditions if necessary. By combining proximity measurements with temperature, capacitance, and movement, if necessary, an algorithm provides assurance that the correct PPE is being worn in a prescribed manner. For example, the BLE microsensor can determine if eyeglasses are in being worn based on the distance between the belt and the sensor or if the glasses are folded up or the tines extended as required. Similarly, the sensors can determine if a safety glove is being worn or not, or if a respiratory mask is in the correct position. The system can also be used to determine if the wrong type of PPE is being worn. For example, clear lens safety glasses instead of tinted glasses, or the wrong type of gloves, or the like. This information is then communicated to the software application and used to create alerts (if necessary) or displayed on the dashboard.

The BLE microsensor component is very small and lightweight, and can be physically integrated into each PPE device. Additional sensors may be added to the BLE microsensor to monitor specific activities or risk conditions, including temperature sensors, gas monitors, impact sensors, accelerometers, electrical sensors, touch sensors, and the like. While BLE microsensors are described herein, other near-field communication devices may be employed, including RFID (radio frequency identification sensor).

The belt-worn transceiver system connects each user and their PPE to the computer network such as the cloud. The system is a small and lightweight mobile device that is worn on the belt of the worker or visitor. Each belt-worn transceiver is uniquely identified in the software system, to allow for identification of individuals, which can be used for safety compliance as described as well as monitoring to ensure that workers are in the right area and not operating equipment that they are not qualified or authorized to operate (regardless of whether they have on the required PPE).

Each belt work device includes one or more (preferably all) of the following components and features.
Rechargeable Lithium Ion battery capable of wireless charging.
GPS radio for real time location.
3G cellular radio for connectivity.
Wi-Fi radio for alternative connectivity indoors.
Height sensor and radio connectivity to interior positioning system.
BLE receiver for connectivity to worker worn smart PPE.
Optional sensing including impact, temperature, accelerometer, shock vibration, motion, altitude, gas, gyro (angular rate sensors or angular velocity), etc.

The various communication systems are used to communicate sensor information to hardware components located throughout the work area, which are then connected to the network running the software.

Each worker and/or visitor entering an established location is issued and wears the belt-worn personal PPE monitor. The belt-worn device and firmware recognize the wearer location and PPE in use, and compares this data to the organizational safety plan which has been programmed into the system. The device communicates details of location and compliance to the cloud based software system.

The belt-worn device may be small and lightweight. As an alternative, the belt can be replaced with smart-phone hardware as a part of the system, which can be equipped with similar sensing capability. While use of an existing smartphone would be possible, the critical nature of the system makes a dedicated proprietary system which can be closely controlled by safety personnel preferable (for example a screen of the type used with smartphones is not necessary and a device that did not include a screen (or included a less sophisticated screen) would reduce the size and cost of the device). Alternatively, the belt can be replaced with a device that is built into a workers clothing, such as a device that can be placed in a special pants pocket, and the like.

The type of PPE applicable to the present invention includes, head protection, helmets, eye protection, eyewear, safety shields, goggles, respiratory protection, dust masks, CPR mask, hearing protection, ear plugs, ear covers, gloves, apparel, fire resistant clothing, chemical resistant clothing, insulated clothing, fall arrest devices, harness, shoes, boots, footwear, and the like. Furthermore PPE can include devices that are not worn, but need to be in close proximity to a worker, such as a fire extinguisher, eyewash, first aid kit, defibrillator, and the like.

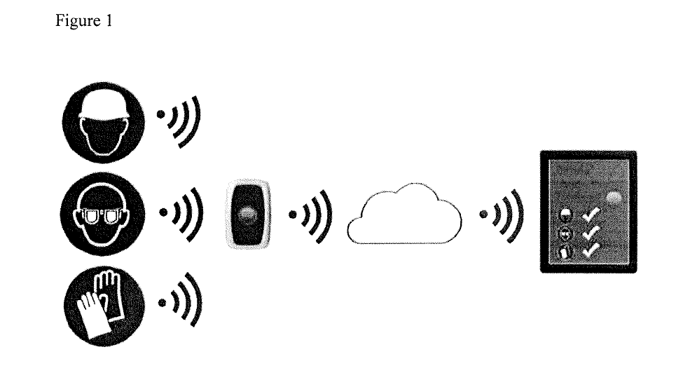

FIG. 1 shows a schematic view of the various components of the present invention.

In particular, the sensors would be embedded into the PPE as shown on the left side of the FIG. 1 (the PPE being a hardhat, eyeglasses, and gloves from top to bottom). The sensor would communicate with the BLE (or other) device (shown in FIG. 1 to the right of the PPEs) that can be worn on a belt, or be designed into a worker's clothing. The device then communicates, for example using a wireless or cellular connection with the network (cloud) to any a computing device upon which the software application runs (shown on the right side of FIG. 1). The computer can then display the pertinent information on a desktop, generate messages, or reports as needed.

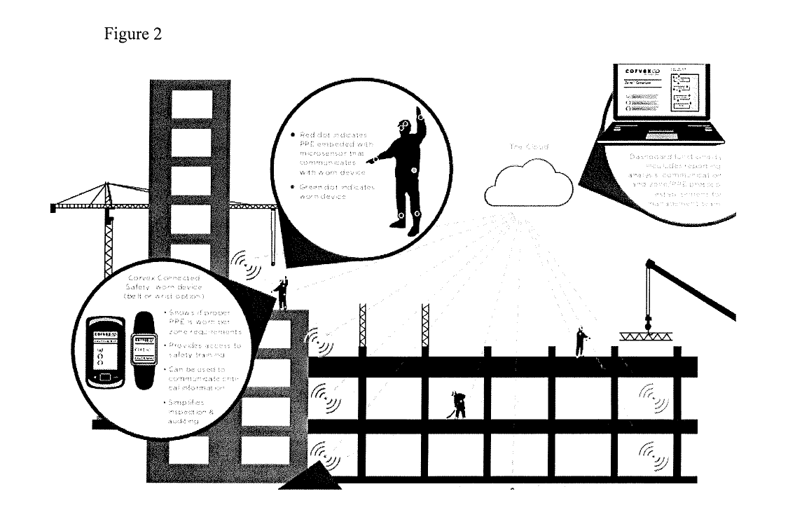

A specific example use case is described for a commercial construction site (see FIG. 2). A commercial construction site can be a complicated work area. There are many workers with different roles and levels of training. Safety hazards are varied and constantly changing. The present invention may be employed to simplify the definition, monitoring, and communication of safety hazards on a construction site.

First, a network of radio beacons are deployed around the site which may be used to track the worker worn mobile transceiver across the work site (shown as partial concentric circles in

FIG. 2), which communicate to a computer system through a communication network (cloud in FIG. 2). Alternatively or additionally, GPS may be employed if a signal is available to track worker location.

Second, the safety plan is defined for the work site and input into the software interface. A risk analysis is completed. PPE and training requirements are defined by worker, role, location, and time of day. The safety plan may be modified by the safety manager at any time. Each worker is also defined as a part of the safety plan, including role, training, and work activities.

Third, the construction worker is issued a mobile transceiver device which is carried on his belt, or on his person. The mobile transceiver device is registered to the individual worker, and connects to the worker profile (role, training, work activities) which is defined in the software. The device can be worn on the workers belt, placed in a pocket, or worn on the workers wrist.

Fourth, the worker is issued the necessary PPE which includes the BLE device. The BLE device identifies the PPE at the serial number level. Examples of PPE might be steel-toed boots, safety glasses, gloves, ear protection, harness, hardhat, safety vest, and the like. In FIG. 2, the worker has BLE enabled PPE including, gloves, hard hat, safety glasses, and boots as indicated by the dots in FIG. 2. The communication device is worn on the workers belt.

Once the worker enters the work site, the location beacons are able to track the worker's location in real time by identifying the worker worn mobile transceiver device. The worker worn mobile transceiver device is able to calculate (as described above) which PPE is being worn by the worker. The workers identity, role, training, work activities, location within the work-site and PPE in use is communicated through the network to the software system.

The software system then compares the specific worker parameters to the safety plan requirements in real time. For example, the system may identify that a worker is working at a restricted height without having the required training or using a fall protection harness.

The system could be employed to notify both the worker and safety manager of the risk, and allow remedial action before an injury occurs.

Furthermore, the present invention involves and utilizes the following aspects and features

Compliance: Worker-worn PPE compliance represents the core functionality of the platform. Workers are located in context of time, location, and role. The platform compares worker-worn PPE to contextual PPE requirements and allows real-time notification of non-compliance to worker and manager (via a computer application safety-dashboard display).

Training: Linkages to specific PPE information and learning management systems allows access to instructions for use and inspection, hazard mitigation, engineering controls and administrative requirements which can be reviewed by the worker on the worn communication device as needed.

Inspection and Audit: PPE inspection protocols are accessed by workers at the point of use. Verification and validation of required inspections may be tracked in real time. Compliance and inspection data may be aggregated for real-time audit activities.

PPE Life In-Use Tracking: Life in-use of expendable PPE may be tracked. Notification and replacement instructions are provided for PPE that has been used beyond safe life in use.

Hazard Abatement: The safety worker may identify, photograph, and quickly communicate information regarding unknown hazards to management. Instructions regarding abatement of hazards from manager to worker may be communicated in real time.

Critical Communication: Contextual alerts and notifications may be delivered to individuals, teams, and organizations across the platform. Management may communicate with workers, teams, and organizations textually and verbally through the personal communication device.

Injured Worker Alerts: Simple functionality for workers to instantly notify management of accident or injury coupled with information regarding location and severity. Real-time linkage to first responders as necessary.

Predictive Modeling: The platform is a learning system. Data-driven “heat maps” defining risk areas may be generated based on team, location, activity, or time.

Supply Chain Optimization: Data defining individual, team and organizational PPE use-pattern trends may be generated to optimize the PPE supply chain. Feedback regarding new PPE evaluation from workers may be easily collected for data-based provisioning of the most effective and worker accepted designs. Unsuitable or ineffective PPE may be quickly identified by the worker and communicated to management.

Reporting and Data: The safety dashboard provides commonly viewed data in an intuitive user interface. Advanced reports may be configured as needed to view and analyze all system data for risk management, insurance, OSHA or for other internal purposes.

These and other advantages will be apparent to those of ordinary skill in the art.

While the various embodiments of the invention have been described in reference to the Figures, the invention is not so limited. Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention. For example, the present invention can be used in a wide variety of different environments where special equipment or gear needs to be or should be used or worn, including, sports, amusement parks/arcades, home, or a variety of work environments such as mines, garages, factories, highways, oil rigs, outdoor work such as landscaping, construction, and the like.

Claiming:

1. A safety compliance monitoring method implemented on an interconnected computer system, comprising:
creating a digital model of a three dimensional space comprising at least one or more work areas;
storing the digital map in the memory of an interconnected computer system for reference and evaluation thereof;
creating a database in the computer system of safety compliance rules implemented within the mapped workspace;
capturing signals within the computer system from one or more persons in the workspace thereby locating them within the mapped workspace;
capturing signals within the computer system to locate one or more safety items within the mapped workspace; and
determining with the computer system whether the person is in compliance with the safety rules.

2. The method of claim 1 where the signals are used to locate the one or more safety items allow locating the safety items in the mapped workspace relative to the person.

3. The method of claim 2 where the signals used to locate the one or more safety items come from sensors embedded in or attached to the safety items.

4. The method of claim 2 where the signals used to locate the one or more safety items come from sensors embedded on or attached to the persons.

5. The method of claim 2 where the signals used to locate the one or more safety items allow the computer system to determine if the safety item is deployed on the person in a manner consistent with the safety compliance rules.

6. The method of claim 1 where the signals captured by the computer system from the one or more persons in the workspace and the one or more safety items, is done by a mobile electronic device worn by the person which communicates wirelessly with the computer system.

7. The method of claim 6 where the device is worn on the person belt that communicates wirelessly with the interconnected computer system.

8. The method of claim 6 where the device is powered by a rechargeable battery capable of wireless recharging.

9. The method of claim 6 where the device has GPS location service capability.

10. The method of claim 6 where the device communicates with the computer system through cellular networks.

11. The method of claim 6 where the device communicates with the computer system though Wi-Fi signals.

12. The method of claim 1 where the signals identify the individual person and workplace rules applicable thereto.

13. The method of claim 1 where the safety rules identify safety items as either mandatory, recommended, or optional.

14. The method of claim 1 where the computer system provides notifications or alerts when there is a safety rule violation.

15. The method of claim 1 where the signals from the one or more safety items come from a BLE sensor attached to the safety items.

16. The method of claim 15 where the BLE sensor senses proximity by measuring signal strength between the BLE sensor and a transceiver worn on the person.

17. The method of claim 16 where the BLE sensor senses temperature and capacitance.

18. The method of claim 1 where the signals from the one or more safety items come from a RFID sensor attached to the safety items.

19. The method of claim 1 where the signals from the one or more safety items within the mapped workspace are affixed to items remote from the person.

20. The method of claim 1 where the signals from the one or more safety items indicate the approximate useful life of the safety items.

21. The method of claim 1 where the database in the computer system of safety compliance rules is based on a person's role, training, location, time during the work day, and certification level.

22. The method of claim 1 where signals within the computer system from the one or more persons in the workspace identify the person(s) by name.

23. The method of claim 14 where the notifications or alerts can be sent to the person in the workspace and/or to a person outside the workspace.

24. The method of claims 17 where the BLE sensor senses one or more of the following acceleration, shock vibration, motion, altitude, presence of a gas, gyro forces, or sound.

25. The method of claim 1 where the signals from the one or more safety items come from a RF sensor attached to the safety items.

26. The method of claim 1 where the safety items, via its signals, interacts with sensors on other safety items, or other person, or other items in the work place.

27. The method of claim 1 where the computer system aggregates signals from a plurality of safety items in the workplace for the purpose of analytics.

28. A safety compliance monitoring method implemented on an interconnected computer system, comprising:
receiving signals from one or more zone beacons that locate one or more work areas within a workspace;
storing the zone beacon information in the memory of an interconnected computer system for reference and evaluation thereof;
creating a database in the computer system of safety compliance rules implemented within the workspace;
capturing signals within the computer system from one or more persons in the workspace thereby locating them within the workspace;
capturing signals within the computer system to locate one or more safety items within the workspace; and
determining with the computer system whether the person is in compliance with the safety rules

29. The method of claim 28 where computer system determines the zone beacons location by triangulation or signal strength.
